(19) United States
(12) Patent Application Publication
(10) Pub. No.: US 2010/0118102 A1
(43) Pub. Date: May 13, 2010

(54) DOUBLE-SIDE PRINTER SYSTEM AND CONTROL METHOD THEREOF

(75) Inventors: Satoshi Yamada, Shinagawa-ku (JP); Hiroyuki Taguchi, Shinagawa-ku (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/691,112

(22) Filed: Jan. 21, 2010

Related U.S. Application Data
(62) Division of application No. 11/681,902, filed on Mar. 5, 2007.

(30) Foreign Application Priority Data
May 29, 2006 (JP) 2006-148489
May 29, 2006 (JP) 2006-148491
May 29, 2006 (JP) 2006-148493
Jun. 2, 2006 (JP) 2006-155025

(51) Int. Cl. B41J 2/00

(52) U.S. Cl. 347/194

(57) ABSTRACT

The embodiments of the present invention relate to a double-side printer system in which two thermal heads printing print data on a front face and a back face of a thermal recording paper in which thermo-sensitive layers are formed on both sides are provided, and when these thermal heads are driven in accordance with the print data, temperatures of these thermal heads are sensed in order to vary print densities of the data to be printed, and ON/OFF times for electrical connections are controlled with respect to heater elements of the respective thermal heads, and to a control method thereof.

### CROSS-REFERENCE TO RELATED APPLICATIONS

This application is a Division of U.S. patent application Ser. No. 11/681,902 filed Mar. 5, 2007, which is based upon and claims the benefit of priority from prior Japanese Patent Applications No. 2006-148489, filed May 29, 2006; No. 2006-148491, filed May 29, 2006; No. 2006-148493, filed May 29, 2006; and No. 2006-155025, filed Jun. 2, 2006, the entire contents of all of which are incorporated herein by reference.

### BACKGROUND OF THE INVENTION

1. Field of the Invention

The present invention relates to a printer system which carries out thermo-sensitive printing onto a thermal recording paper having thermo-sensitive layers on its both sides, and a control method thereof.

2. Description of the Related Art

Generally, in a printer printing images and characters on a recording paper, a record head is provided at one surface side (for example, a front face side) of a recording paper, and print processing is carried out onto a carried recording medium. Therefore, images and characters are usually printed on only the one side surface of the recording paper. When printing is carried out onto the back face of the printing paper, an inverting function (a both-side unit) of inverting the front and back faces of the recording paper as proposed in Jpn. Pat. Appln. KOKAI Publication No. 11-286147 is used.

Further, with respect to a thermal recording paper which is rolled up in a roll form, and in which a thermo-sensitive layer is formed on one side, thermal printing of an image is carried out onto the thermo-sensitive layer by one thermal head, and the thermal recording paper is cut by a cutter to be discharged. In recent years, a thermal recording paper having thermo-sensitive layers on its both sides has been coming into practical use. In double-side printing onto the double-side thermal recording paper as well, after an images is formed on one side, the paper is inverted and returned to the thermal head again, and an image is formed on the other side (for example, Jpn. Pat. Appln. KOKAI Publication Nos. 9-233256 and 6-24082).

For example, in Jpn. Pat. Appln. KOKAI Publication No. 11-286147 or U.S. Pat. No. 6,759,366, there is disclosed a recording paper in which it is possible to print on the both sides by using a double-side printer having two thermal heads. In this double-side printer, the thermal heads are disposed on the respective sides of a thermal recording paper to be carried. These thermal heads allow images and characters to be printed on the both sides of a thermal recording paper without carrying out inversion feeding.

### BRIEF SUMMARY OF THE INVENTION

An embodiment subordinate to the present invention provides a double-side printer system comprising: a paper-feed unit which feeds a thermal recording paper in which thermo-sensitive layers are formed on front and back faces serving as a first recording surface and a second recording surface, in a direction of paper feeding determined in advance; a first thermal head which has a plurality of heater elements arrayed in a line form in a direction perpendicular to the direction of paper feeding, and which prints first information on the first recording surface of the thermal recording paper; a second thermal head which has a plurality of heater elements arrayed in a line form in a direction perpendicular to the direction of paper feeding, and which prints second information on the second recording surface of the thermal recording paper; a first temperature sensor which senses a temperature of the first thermal head; a second temperature sensor which senses a temperature of the second thermal head; a driving unit which turns on/off electrical connections to said each thermal head; and a control unit which controls an electrical connection ON time with respect to the heater elements of the first thermal head such that a sensed temperature of the first temperature sensor is made to be a set value, and controls an electrical connection ON time with respect to the heater elements of the second thermal head such that a sensed temperature of the second temperature sensor is made to be a set value.

There is further provided a method for controlling a double-side printer system which prints print data on a thermal recording paper in which thermo-sensitive layers are formed on front and back faces serving as a first recording surface and a second recording surface, the method comprising: respectively sensing temperatures of heater elements provided in a first thermal head which prints print data on the first recording surface, and temperatures of heater elements provided in a second thermal head which prints print data on the second recording surface; and controlling to turn on/off electrical connections to the respective heater elements such that respective sensed temperatures are made to be the same temperature between the thermal heads.

### BRIEF DESCRIPTION OF THE SEVERAL VIEWS OF THE DRAWING

FIG. 1 is a schematic block diagram of a double-side printer system according to a first embodiment;

FIG. 2 is a block diagram of a control circuit of the first embodiment;

FIG. 3 is a block diagram showing a specific structure of a thermal head according to the first embodiment;

FIG. 4 is a diagram showing a format of print data D0 according to the first embodiment;

FIG. 5 is a diagram showing a printed result according to the first embodiment;

FIG. 6 is a flowchart for explanation of operations of the first embodiment;

FIG. 7 is a block diagram showing a structure of a control unit of a double-side printer system according to a second embodiment;

FIG. 8 is a diagram showing a structure of a table in which reference electrical connection times are set, which is used in the second embodiment;

FIG. 9 is a flowchart for explanation of setup processing by a host device of the second embodiment;

FIG. 10 is a diagram showing a printed result of setting information according to the double-side printer system of the second embodiment;

FIG. 11 is a flowchart for explanation of print processing according to the double-side printer system of the second embodiment;

FIG. 12 is a block diagram showing a structure of a control unit of a double-side printer system according to a third embodiment;

FIG. 13 is a diagram showing a structure of a memory unit which manages information on respective thermal heads according to the third embodiment;

FIG. 14 is a flowchart for explanation of setup processing by a host device according to the third embodiment;

FIG. 15 is a diagram showing a printed result of information on a first thermal head in the double-side printer system according to the third embodiment;

FIG. 16 is a diagram showing a printed result of information on a second thermal head in the double-side printer system according to the third embodiment;

FIG. 17 is a diagram showing a conceptual structure of a character attribute managing system mounted in a double-side printer which carries out double-side printing by thermal heads according to a fourth embodiment;

FIG. 18 is a flowchart for explanation of printing-out of the double-side printer system according to the fourth embodiment;

FIG. 19 is a flowchart for explanation of a subroutine of instructing a print style according to the fourth embodiment;

FIG. 20 is a flowchart for explanation of a subroutine of editing character data according to the fourth embodiment;

FIG. 21 is a flowchart for explanation of a subroutine of editing character data according to a fifth embodiment; and

FIG. 22 is a flowchart for explanation of printing-out of a double-side printer system according to the fifth embodiment.

### DETAILED DESCRIPTION OF THE INVENTION

Hereinafter, embodiments subordinate to the present invention will be described in detail with reference to the drawings.

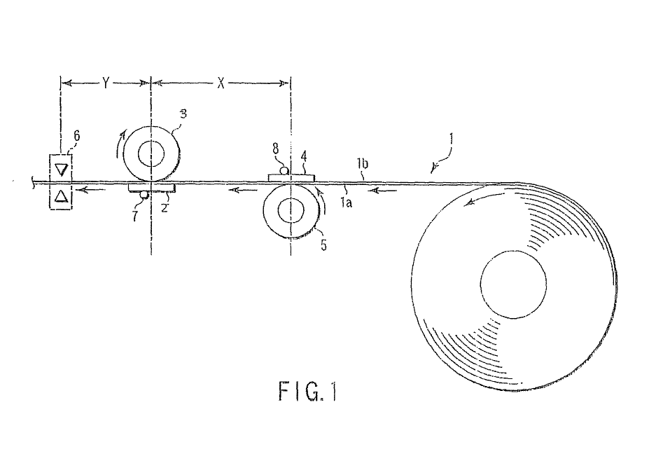

FIG. 1 shows a schematic structure of a printer according to a first embodiment. The first embodiment is to provide a double-side printer system carrying out double-side printing in rapid printing-out and in stable densities, and a control method thereof.

A recording paper used in the present invention is a long thermal recording paper 1 rolled up in a roll form. Thermo-sensitive layers are respectively formed on a front face (or called a first recording surface) 1a and a back face (or called a second recording surface) 1b of the thermal recording paper 1. The thermal recording paper 1 is rolled up in a roll form such that the front face 1a is on the inside. The thermal recording paper 1 is pulled out and fed in the direction of arrows shown in the diagram by a paper-feed mechanism 22 which will be described later. The above-described thermo-sensitive layers are formed from a material coloring black, red, or the like when it is heated to a predetermined temperature or more.

As shown in FIG. 1, a first thermal head 2 for recording image information, character information, or the like so as to contact the front face 1a of the thermal recording paper 1, and a second thermal head 4 for recording image information, character information, or the like so as to contact the back face 1b thereof are provided along the direction of feeding (arrows) the thermal recording paper 1. With respect to both of these first and second thermal heads 2 and 4, many heater elements are arrayed in a line form in a direction perpendicular to the direction of feeding the thermal recording paper 1.

In the present embodiment, the first and second thermal heads 2 and 4 are to be spaced along the direction of feeding the thermal recording paper 1, and the first thermal head 2 is disposed at a downstream side in the direction of paper feeding from the second thermal head 4. Moreover, first and second temperature sensors 7 and 8 are respectively attached to the first and second thermal heads 2 and 4. These temperature sensors 7 and 8 detect temperatures T1 and T2 of the first and second thermal heads 2 and 4.

A first platen roller 3 is installed at a position facing the first thermal head 2 with the thermal recording paper 1 sandwiched therebetween. In the same way, a second platen roller 5 is installed at a position facing the second thermal head 4 with the thermal recording paper 1 sandwiched therebetween. These first and second platen rollers 3 and 5 operate such that the thermal recording paper 1 is carried so as to be appressed against the first and second thermal heads 2 and 4 by an unillustrated biasing means.

Moreover, a cutter 6 which cuts the thermal recording paper 1 onto which recording has been carried out at a side astern of the printed region thereof is provided at a downstream side in the direction of paper feeding from the first thermal head 2. Suppose that a distance between the second thermal head 4 at the upstream side and the first thermal head 2 at the downstream side is a “distance X”, and a distance between the first thermal head 2 and the cutter 6 is a “distance Y”.

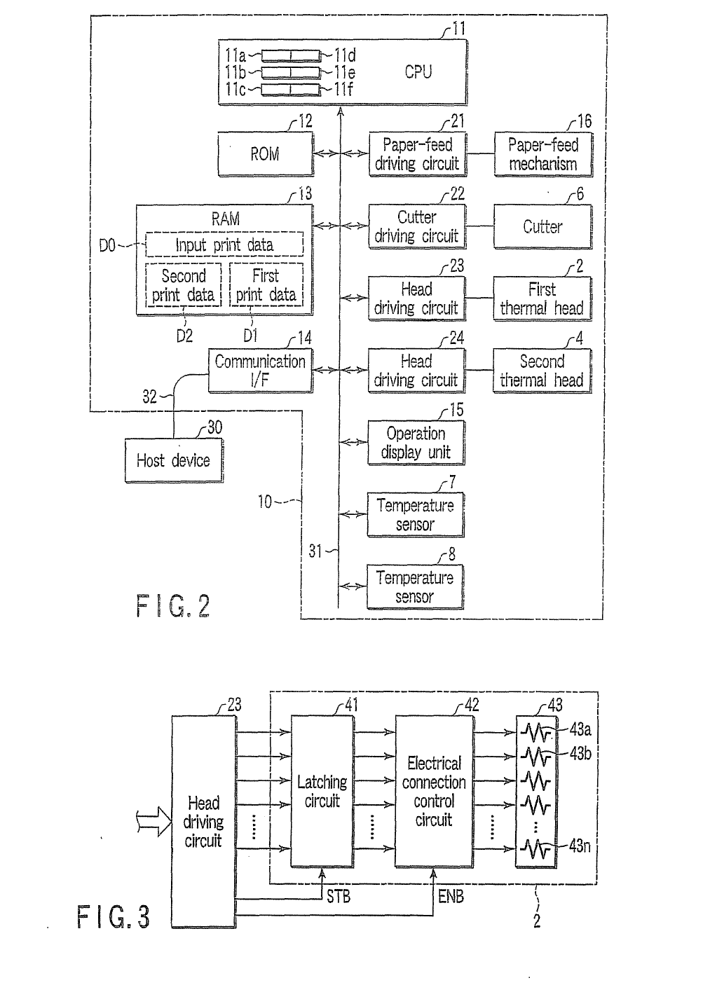

A structural example of a control circuit of a thermal printer body 10 including the structure shown in FIG. 1 is shown in FIG. 2. This printer system is structured from the thermal printer body 10 and a host device 30 which is connected thereto from the outside.

In this structure, a ROM 12 which is formed from a nonvolatile memory for storing a control program, a RAM 13 which is formed from a rewritable volatile memory for storing data, a communication interface 14 which is for carrying out data transmission/reception with the host device 30, an operation display unit 15 for setting operating conditions, a paper-feed driving circuit 21 which drives a paper-feed mechanism 16 for the thermal recording paper 1, a cutter driving circuit 22 which drives the cutter 6, a first head driving circuit 23 which drives the first thermal head 2, a second head driving circuit 24 which drives the second thermal head 4, and the temperature sensors 7 and 8 which measure temperatures of the thermal heads, or the like are connected via a bus 31 to a CPU 11 which is a main control unit. Moreover, the communication I/F 14 is connected to the host device 30 via a communication cable 41, whereby communication between the host device 30 and the CPU 11 is carried out.

On the other hand, the CPU 11 has the following (1) to (6) control functions as principal functions.

(1) A data dividing control function 11a by which print data D0 inputted from the external host device 30 is divided into first print data D1 with respect to the front surface 1a of the thermal recording paper 1 and second print data D2 with respect to the back surface 1b.

(2) An electrical connection control function 11b by which driving of turning on/off electrical connections to the heater elements of the first thermal head 2 in accordance with the first print data D1 is controlled, and driving of turning on/off electrical connections to the heater elements of the second thermal head 4 in accordance with the second print data D2 is controlled.

(3) An electrical connection time calculating function 11c by which electrical connection ON times with respect to the respective heater elements of the first thermal head 2 are controlled such that a sensed temperature T1 of the temperature sensor 7 is made to be a set value T1s, and electrical connection ON times with respect to the respective heater elements of the second thermal head 4 are calculated such that a sensed temperature T2 of the temperature sensor 8 is made to be a set value T2s.

(4) A print control function 11d by which driving of the second thermal head 4 corresponding to the second print data D2 is started in the first place while the thermal recording paper 1 is fed, and when a print starting position referenced on the driving is made to correspond to the first thermal head 2, driving of the first thermal head 2 corresponding to the first print data D1 is started.

(5) A stop control function 11e by which, when a sensed temperature T1 of the temperature sensor 7 abnormally rises to reach an upper limit T1max, or a sensed temperature T2 of the temperature sensor 8 abnormally rises to reach an upper limit T2max, the driving of the first and second thermal heads 2 and 4 is stopped, and the fact of the stop is reported on a display of the operation display unit 15.

(6) A density control function 11f by which densities of print data to be printed on the thermal recording paper 1 are set.

Note that the first thermal head 2 has a latching circuit 41, an electrical connection control circuit 42, and an edge head 43 as shown in FIG. 3. The edge head 43 has many heater elements 43a, 43b, . . . , and 43n for thermal transfer printing which are arranged in a line form. The latching circuit 41 latches the first print data D1 supplied from the head driving circuit 23 for every line in accordance with a strobe signal STB from the head driving circuit 23. The electrical connection control circuit 42 controls electrical connections to the heater elements 43a, 43b, . . . , and 43n of the edge head 43 to be turned on/off in accordance with the data in the latching circuit 41, and in a timing when an enable signal ENB supplied from the head driving circuit 23 gets active.

Electrical connection ON times with respect to the respective heater elements are varied by changing a length of a time for which an enable signal ENB is being active. When an electrical connection ON time is varied, a heat temperature of each heater element is varied. Further, the structure of the second thermal head 4 is the same as that of the first thermal head 2, and description thereof will be omitted.

Next, operations of the double-side printer system structured as described above will be described.

The print data D0 is inputted via the communication I/F 14 from the external host device 30, and is stored in the RAM 13.

In accordance with this storage, the print data D0 is sorted into the first print data D1 and the second print data D2. Quantities or conditions of sorting are set by an operation by the operation display unit 15 or a command from the host device 30. As quantities of sorting, there is, for example, “50% versus 50%”, and as conditions of sorting, there are, for example, data types. As types of data, for example, in the case of a sales receipt of a shop, there are a money character, an announcement text, a sales message, an illustration for customers, and the like.

In FIG. 4, an example in which the print data D0 is sorted into the first print data D1 and the second print data D2 is shown. Namely, the print data D0 formed from print data on the first line to the hundredth line is sorted with a central boundary location C serving as a boundary. Specifically, the print data D0 is sorted into the first print data D1 formed from the print data on the first line to the fiftieth line and the second print data D2 formed from the print data on the fifty-first line to the hundredth line. The sorted first print data D1 and second print data D2 are stored in the RAM 13. Note that, when there is data on a boundary location C, the data is sorted into one of the first print data D1 and the second print data D2 under a condition determined in advance.

After this sorting, the thermal recording paper 1 is fed, and the second thermal head 4 is first driven by the second print data D2 to print the print data on the fifty-first line to the hundredth line on the back face 1b of the thermal recording paper 1. The thermal recording paper 1 is further carried, and when a print starting position on the back face 1b side is on a recording position of the first thermal head 2, the first thermal head 2 is driven by the first print data D1 to print the print data on the first line to the fiftieth line on the front face 1a.

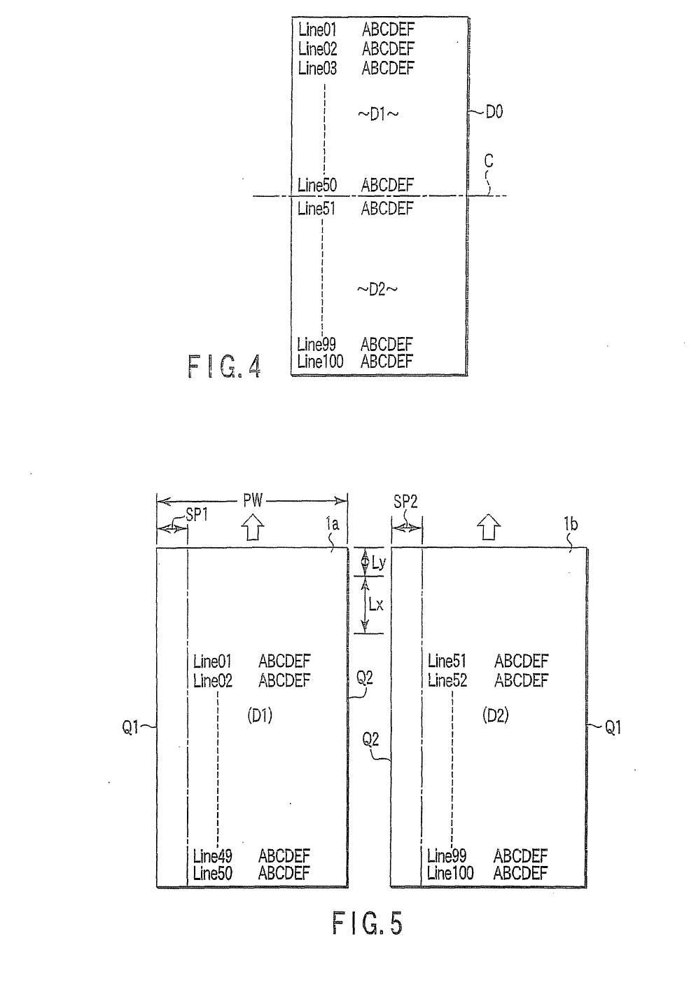

As shown in FIG. 5, due to such printing-out, the print data on the first line to the fiftieth line which are the first print data D1 are printed on the front face 1a of the thermal recording paper 1, and the print data on the fifty-first line to the hundredth line which are the second print data D2 are printed on the back face 1b of the thermal recording paper 1. In this case, on the front face 1a of the thermal recording paper 1, a space area with a width of SP1 is allocated between a starting position of the respective character rows to be printed and one end Q1 in the width direction. On the back face 1b of the thermal recording paper 1, a space area with a width of SP2 is allocated between a starting position of the respective character rows to be printed and the other end Q2 in the width direction.

Further, in front end sides of the front face 1a and the back face 1b of the thermal recording paper 1, space areas Ly corresponding to the distance Y from the cutter 6 to the first thermal head 2 are generated, and space areas Lx corresponding to the distance X from the first thermal head 2 to the second thermal head 4 are generated. The printed thermal recording paper 1 is cut by the cutter 6 to be provided to a user.

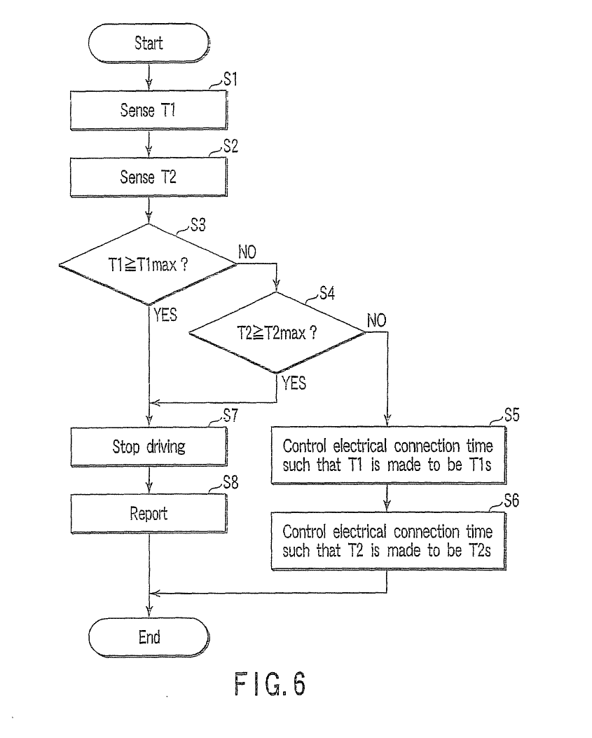

Here, a control method for carrying out double-side printing in stable densities will be described with reference to a flowchart shown in FIG. 6.

At the time of printing print data on the thermal recording paper 1, a temperature T1 of the first thermal head 2 is sensed by the temperature sensor 7 (step S1), and a temperature T2 of the second thermal head 4 is sensed by the temperature sensor 8 (step S2).

Next, the sensed temperature T1 is compared with the upper limit T1max determined in advance (step S3). In this comparison of the sensed temperature T1, when the sensed temperature T1 is less than the upper limit T1max (NO), the sensed temperature T2 is compared with the upper limit T2max determined in advance (step S4). In this comparison of the sensed temperature T2, when the sensed temperature T2 is less than the upper limit T2max (NO), electrical connection ON times with respect to the respective heater elements of the first thermal head 2 are controlled such that the sensed temperature T1 is made to be a set value T1s (step S5). At the same time, electrical connection ON times with respect to the respective heater elements of the second thermal head 4 are controlled such that the sensed temperature T2 of the temperature sensor 8 is made to be a set value T2s (step S6). In this processing, when a sensed temperature is higher than a set value, heating values are reduced based on the judgment that printing in sufficient densities is possible even if heating values of the heater elements are reduced. On the other hand, when a sensed temperature is lower than a set value, heating values are increased based on the judgment that printing in sufficient densities cannot be achieved if heating values of heater elements are not increased.

Further, when the sensed temperature T1 rises to reach the upper limit T1max (YES) in the judgment at step S3, or when the sensed temperature T2 rises to reach the upper limit T2max (YES) in the judgment at step S4, driving of the first and second thermal heads 2 and 4 is stopped for safety purposes (step S7). Then, the fact of the stop is reported on a display of the operation display unit 15 (step S8).

As described above, the first and second thermal heads 2 and 4 which carry out printing onto the front face 1a and the back face 1b of the double-side thermal recording paper 1 in which thermo-sensitive layers are formed on the both sides are provided, and these thermal heads 2 and 4 are respectively driven in accordance with print data, making it possible to rapidly carry out double-side printing.

Further, at the time of carrying out double-side printing, electrical connection ON times with respect to the respective heater elements of the first thermal head 2 are controlled such that a temperature T1 of the first thermal head 2 is made to be a set value T1s to be a desired density. At the same time, electrical connection ON times with respect to the respective heater elements of the second thermal head 4 are controlled such that a temperature T2 of the second thermal head 4 is made to be a set value T2s to be a desired density (a density which is the same as that of the first thermal head 2). It is possible to always carry out double-side printing in stable densities due to such thermal management by controlling electrical connections.

Next, a double-side printer system according to a second embodiment will be described.

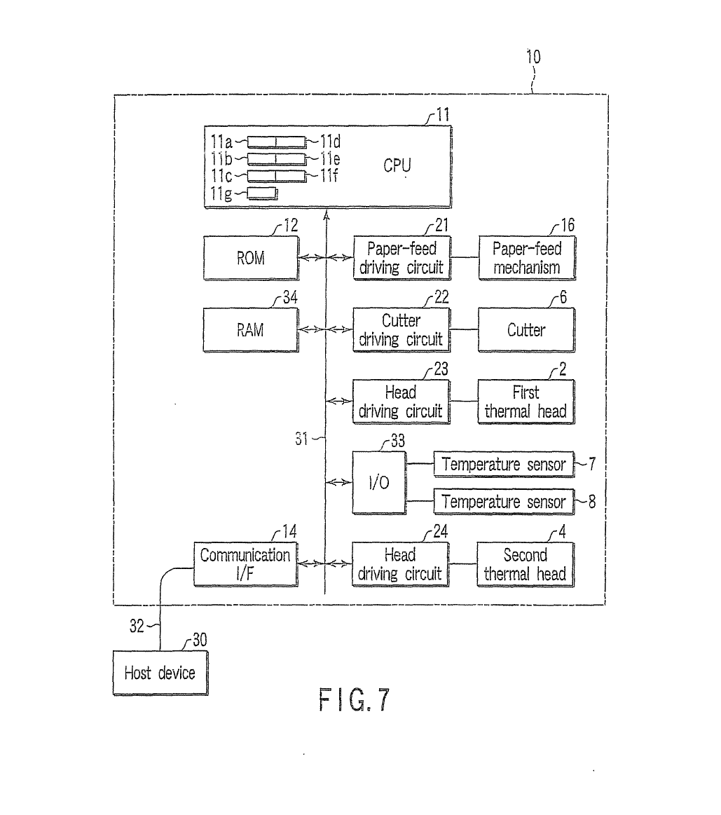

FIG. 7 is a diagram showing a structure of a control unit of the double-side printer system according to the second embodiment. The present embodiment is to provide a printer system capable of individually setting print densities by a first thermal head which carries out printing onto a front face of a double-side thermal recording paper, and a second thermal head which carries out printing onto a back face thereof, and to provide a method for setting the print densities. Note that, among constitutional parts in the present embodiment, constitutional parts which are the same as those in the first embodiment described in FIGS. 1 to 6 are denoted by the same reference numerals, and descriptions thereof will be omitted. The first and second thermal heads 2 and 4, the first and second platen rollers 3 and 5, and the cutter 6 are structured in the same way as in the first embodiment describe above.

This printer system is structured from a thermal printer body 10 and a host device 30 which is connected thereto from the outside.

The thermal printer body 10 is, in the same way as in the first embodiment described above, structured from a CPU 11, a ROM 12, a RAM 34 formed from a rewritable volatile memory for storing data, a paper-feed driving circuit 21 driving a paper-feed mechanism 16, head driving circuits 23 and 24 respectively driving the first and second thermal heads 2 and 4, a cutter driving circuit 22 driving the cutter 6, first and second temperature sensors 7 and 8, and an I/O port 33 to which the temperature sensors 7 and 8 are connected, and those are electrically connected via a bus line 31 to the CPU 11. The respective thermal heads 2 and 4 are structured in the same way as those of FIG. 3 described above.

The CPU 11 of the present embodiment has the data dividing control function 11a, the electrical connection control function 11b, the electrical connection time calculating (or temperature setting control function) 11c, the print control function 11d, the stop control function 11e, and the density control function 11f which have been descried above, and further has a table 11g in which reference electrical connection times with respect to the respective heater elements of the first and second thermal heads which correspond to sensed temperatures are set. Further, the electrical connection time calculating function 11c of the control unit 11 reads out a corresponding reference electrical connection time from the table 11g on the basis of a sensed temperature of the first temperature sensor 7 at the time of printing by the first thermal head 2. The electrical connection time calculating function 11c has a first electrical connection time calculating function by which an electrical connection time with respect to a heater element is calculated on the basis of the reference electrical connection time and print density information set by the density control function 11f, and a second electrical connection time calculating function by which a corresponding reference electrical connection time is read out from the table 11g on the basis of a sensed temperature of the second temperature sensor 8 at the time of printing by the second thermal head 4, and an electrical connection time with respect to a heater element is calculated on the basis of the reference electrical connection time and print density information set by the density control function 11f.

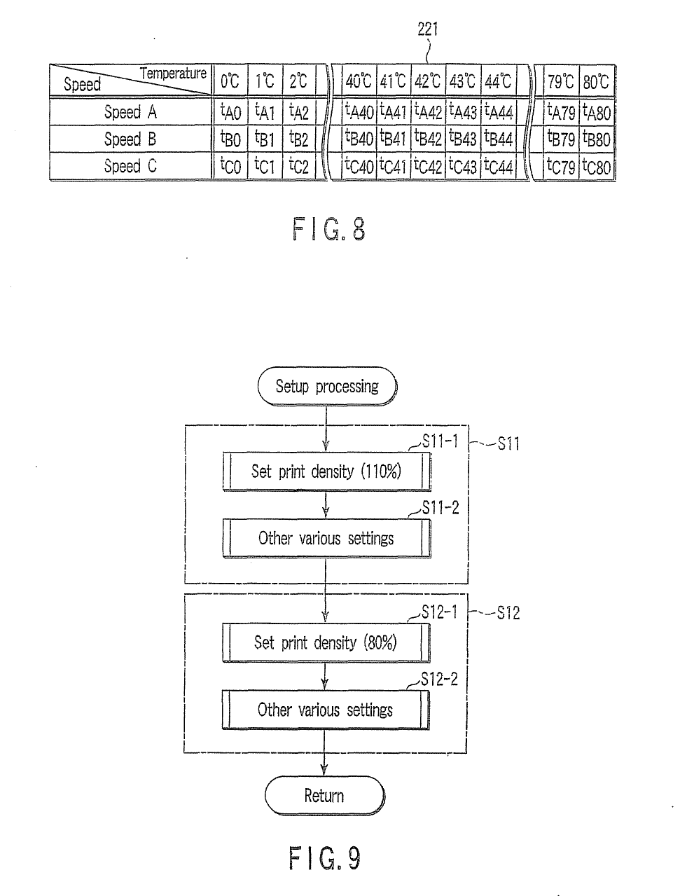

In the ROM 34 in the present embodiment, for example, as shown in FIG. 8, a table 36 is provided in which reference electrical connection times with respect to the heater elements are set at each degree from 0° C. to 80° C. so as to correspond to three types of speeds A, B and C. Namely, at a speed A, reference electrical connection times t_{A0}, t_{A1}, t_{A2}, . . . , t_{A40}, t_{A41}, t_{A42}, t_{A43}, t_{A44}, . . . t_{A79}, and t_{A80} are set at 0° C. to 80° C. At a speed B, reference electrical connection times t_{B0}, t_{B1}, t_{B2}, . . . , t_{B40}, t_{B41}, t_{B42}, t_{B43}, t_{B44}, . . . t_{B79}, and t_{B80} are set at 0° C. to 80° C. At a speed C, reference electrical connection times t_{C0}, t_{C1}, t_{C2}, . . . , t_{C40}, t_{C41}, t_{C42}, t_{C43}, t_{C44}, . . . t_{C79}, and t_{C80} are set at 0° C. to 80° C.

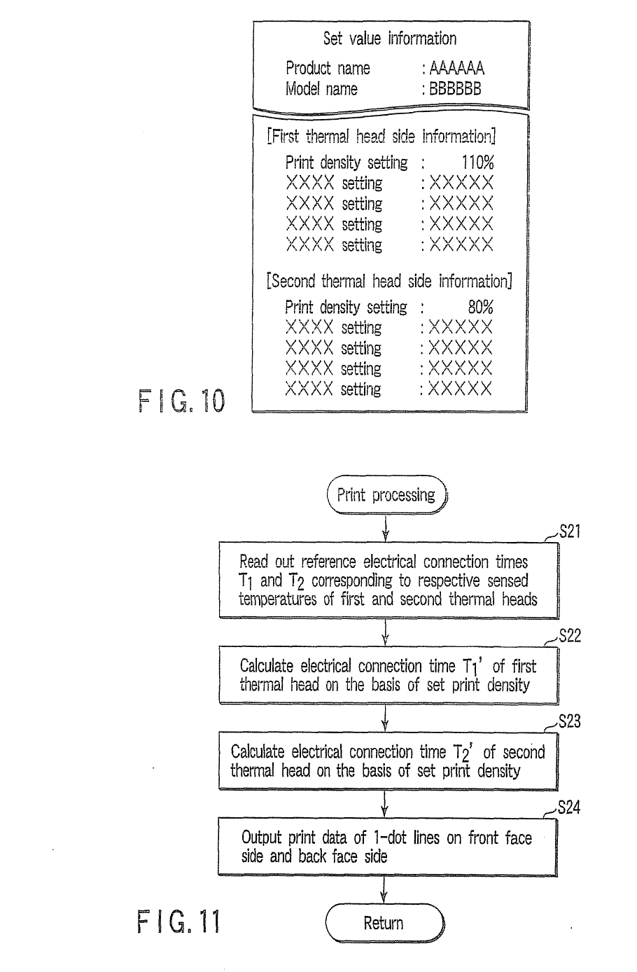

The thermal printer body 10 is to individually set the print densities of the respective thermal heads 2 and 4 in proportion to an increase or a decrease with respect to the reference electrical connection times of the table 25 shown in FIG. 8. Data input at the time of setting is carried out from the outside by using the host device 30. In the present embodiment, unillustrated means for setting print densities, or the like is provided in the host device 30, and setup processing is carried out as shown in FIG. 9. Various settings including print densities with respect to the thermal printer body 10 are carried out by the setup processing.

Setup processing shown in FIG. 9 will be described.

First, settings for the first thermal head 2 are carried out (step S11), after which settings for the second thermal head 4 are carried out (step S12). At the setting process at step S11, processing for setting print densities (by an unillustrated print density setting unit) is carried out in the first place (step S11-1), and next, other various setting processes are carried out (step S11-2). In this print density setting, a rate of increase or decrease with respect to a reference electrical connection time, for example, 110% is set with respect to a reference electrical connection time.

Next, the settings for the second thermal head 4 at step S12 are carried out. At this setting process, processing for setting print densities (by print density setting means) is carried out (step S12-1), and other various setting processes are carried out (step S12-2). In this print density setting, a rate of increase or decrease with respect to a reference electrical connection time, for example, 80% is set with respect to a reference electrical connection time. The setting information from the host device 30 is to be written into a memory unit which is formed at a part of the RAM 34 in the thermal printer body 10 and in which a memory is held by backing up the power supply.

When the various settings with respect to the thermal printer body 10 by the host device 30 are completed, the thermal printer body 10 carries out printing-out of the a variety of setting information onto the front face 1a of the double-side thermal recording paper 1 as shown in FIG. 10 by using the first thermal head 2.

In the present embodiment, when the print data is received at the communication I/F 14 from the host device 30, the CPU 11 stores the received print data into the RAM 34. Thereafter, the print data is divided into print data to be printed by the first thermal head 2 and print data to be printed by the second thermal head 4, and those are respectively edited as bitmap data. A rate of dividing is not particularly limited. In the present embodiment, for example, an example in which print data are divided into two equal parts will be described.

Next, the CPU 11 outputs the bitmap data by each one dot line to the head driving circuits 23 and 24. The head driving circuits 23 and 24 respectively drive the first and second thermal heads 2 and 4 to carry out printing-out by each one dot line onto the front face 1a and the back face 1b of the double-side thermal recording paper 1.

At this time, the CPU 11 executes print processing in accordance with the flowchart shown in FIG. 11.

First, a signal that a temperature state of the first thermal head 2 is sensed is taken in from the first temperature sensor 7, and a signal that a temperature state of the second thermal head 4 is sensed is taken in from the second temperature sensor 8. Then, a corresponding reference electrical connection time T1 is read out from a table 52 shown in FIG. 13 on the basis of the sensed temperature of the first thermal head 2. In addition thereto, a corresponding reference electrical connection time T2 is read out on the basis of the sensed temperature of the second thermal head 4 (step S21).

Thereafter, an electrical connection time T1′ of actual electrical connection is calculated on the basis of the electrical connection time T1 read out on the basis of the sensed temperature of the first thermal head 2, and the set print density 110% (step S22). Moreover, an electrical connection time T2′ of actual electrical connection is calculated on the basis of the electrical connection time T2 read out on the basis of the sensed temperature of the second thermal head 4, and the set print density 80% (step S23).

Next, the thermal heads 2 and 4 are respectively driven by the head driving circuits 23 and 24 to carry out printing of each one dot line onto the front face 1a and the back face 1b of the double-side thermal recording paper 1 (step S24). Then, when the printing of each one dot line is completed, the processing is returned to the main routine. Thereafter, when the print processing of the following each one dot line is carried out, the print processing of FIG. 11 is repeated again.

In the structure of the present embodiment described above, the print data are divided at a desired proportion, and are printed out on the front face 1a and the back face 1b of the double-side thermal recording paper 1 by using the first thermal head 2 and the second thermal head 4, which makes it possible to save a quantity consumed of the thermal recording paper 1.

Further, the first thermal head 2 and the second thermal head 4 are disposed at different positions (above and below with the thermal recording paper 1 therebetween) so as to be spaced, which generates a difference in the ambient temperatures. Further, there is a manufacturing error in the heater elements provided in the thermal heads, which generates a difference in the head temperatures. Moreover, dispersion is generated in the thermo-sensitive characteristics at the front face side and the back face side in the double-side thermal recording paper 1. Considering these respective factors, it is impossible to uniform the print densities on the front and back faces of the double-side thermal recording paper 1 with a unique setting for print densities.

Then, in the present embodiment, head temperatures of the first thermal head 2 and the second thermal head 4 are individually sensed by the first temperature sensor 7 and the second temperature sensor 8, and corresponding reference electrical connection times are read out from the table 52 so as to correspond to the sensed temperatures. In this way, it is possible to vary a reference electrical connection time to be used in accordance with a difference in head temperatures of the first thermal head 2 and the second thermal head 4.

Then, settings of print densities are adjusted in accordance with a percentage of increase or decrease of the reference electrical connection times serving as references. Namely, when printing is carried out on the front face 1a of the double-side thermal recording paper 1 by using the first thermal head 2, a print density is set to, for example, 110%, i.e., an increase by 10% from the reference electrical connection time. On the other hand, when printing is carried out on the back face 1b of the double-side thermal recording paper 1 by using the second thermal head 4, a print density can be set to 80%, i.e., a decrease by 20% from the reference electrical connection time.

In this way, since temperatures of the first thermal head 2 and the second thermal head 4 are actually measured, and electrical connection times are adjusted with reference to the table determined in advance, it is possible to individually adjust print densities on the front face 1a and the back face 1b of the double-side thermal recording paper 1. Accordingly, it is possible to easily realize that the front face 1a and the back face 1b of the double-side thermal recording paper 1 are set to have the same print density. It goes without saying that it is possible to easily carry out printing-out in different densities appropriately.

In the setting for conforming the front face 1a and the back face 1b of the double-side thermal recording paper 1 to the same print density, a test printing is carried out by the first thermal head 2 for a predetermined electrical connection time (a reference electrical connection time or an electrical connection time arbitrarily set), and an increase or a decrease in time is set with reference to the table so as to have a desired density to the sight. Next, a test printing is carried out by the second thermal head 4 for an electrical connection time which is the same as the predetermined one, and an increase or a decrease in time is set so as to have a desired density to the sight. At this time, provided that an increase or a decrease in time is set so as to have the same density to the sight, it is possible to make the front and back faces of the double-side thermal recording paper 1 have the same print density. When the desired print densities of the front face 1a and the back face 1b of the double-side thermal recording paper 1 are determined by carrying out such test printings, it suffices to carry out settings for print densities by carrying out the setup processing shown in FIG. 9 by the host device 30.

Further, as shown in FIG. 10, because the print density information on the set print densities is printed on the thermal recording paper 1 along with the other setting information, it is possible to confirm the contents of the settings. Further, printing of the setting information may be carried out on any of the front face 1a and the back face 1b of the thermal recording paper 1, and may be carried out separately by each thermal head.

Further, it is usually impossible to ignore a change in head temperatures for print densities in thermo-sensitive printing using the thermal heads. In the present embodiment, since a head temperature is measured every printing of one dot line, a corresponding electrical connection time is read out from the table 52 in accordance with the measured head temperature, which makes it possible to realize a fine temperature adjustment.

Note that a variety of setting information including print densities has been set in the thermal printer body 10 by the host device 30. However, this is not limited thereto, and an operating unit formed from an input unit and a display unit may be provided in the thermal printer body 10, and a variety of setting information may be directly set at the thermal printer body 10 side. Further, the double-side thermal recording paper has been used as a thermo-sensitive printing medium. However, this is not necessarily limited thereto, and a thermo-sensitive printing medium formed from a sheet-like synthetic resin material can be easily applied to the invention.

Next, a double-side printer system according to a third embodiment will be described.

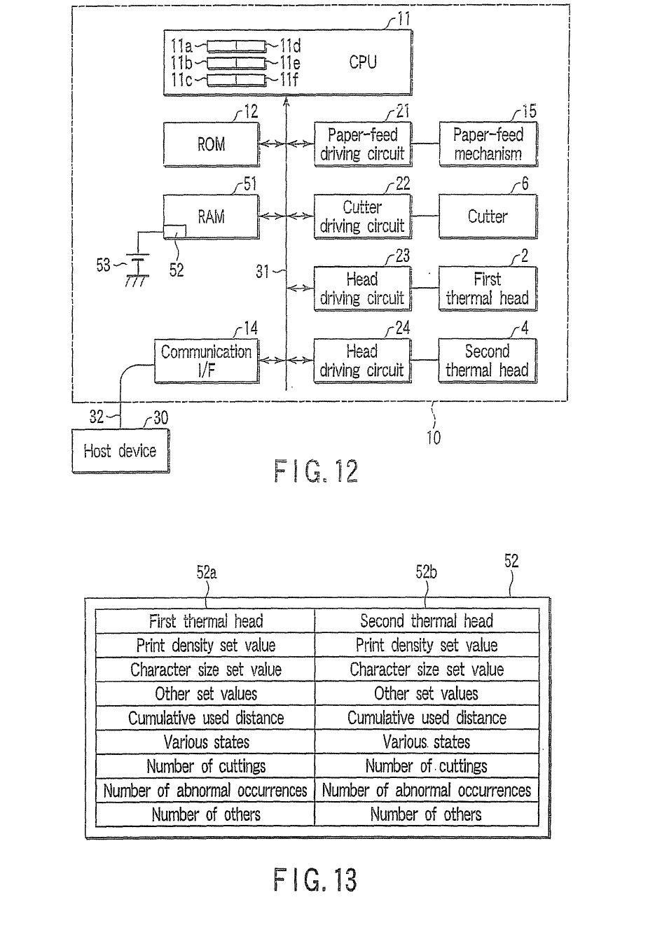

FIG. 12 is a diagram showing a structure of a control unit of the double-side printer system according to the third embodiment. The present embodiment is to manage information on the respective thermal heads for each head, and to carry out printing of print data by the respective thermal heads such that the managed information is divided for each head on the front and back faces of the double-side thermal recording paper, which makes it possible to easily confirm the information on the respective thermal heads. Note that, among the constitutional parts in the present embodiment, constitutional parts which are the same as those in the first embodiment described in FIGS. 1 to 6 are denoted by the same reference numerals, and descriptions thereof will be omitted.

First and second thermal heads 2 and 4, first and second platen rollers 3 and 5, and a cutter 6 in the present embodiment are structured in the same way as those in the first embodiment describe above. This printer system is structured from a thermal printer body 10 and a host device 30 connected thereto from the outside.

The thermal printer body 10 is, in the same way as in the first embodiment described above, structured from a CPU 11, a ROM 12, a RAM 51 which is formed from a rewritable volatile memory for storing data, a paper-feed driving circuit 21 driving a paper-feed mechanism 16, head driving circuits 23 and 24 respectively driving the first and second thermal heads 2 and 4, a cutter driving circuit 22 driving the cutter 6, and a communication I/F 14 connected with a cable 32 for communicating with the host device 30, and those are electrically connected via a bus line 31 to the CPU 11. The respective thermal heads 2 and 4 are structured in the same way as those of FIG. 3 described above.

The RAM 51 in the present embodiment is structured from a plurality of memory devices, and a memory device 52 serving as a part of those is always backed up by a power supply 53 to store information. In the memory device 52, as shown in FIG. 13, an area 52a in which head information on the first thermal head 2 is stored, and an area 52b in which head information on the second thermal head 4 is stored are provided.

The head information in the area 52a and the head information the area 52b shown in FIG. 13 are the same type of information, and for example, those are various set values including print density set values and character size set values, various states including cumulative used distances serving as data in which distances of the thermal recording paper 1 used for printing by the heads are summed up, and various numbers of times including the number of cuttings of the thermal recording paper 1 and the number of abnormal occurrences in the respective heads.

The thermal printer body 10 is to individually set print densities of the respective thermal heads 2 and 4 in proportion to an increase or a decrease with respect to the reference electrical connection times stored in the table of the ROM 12. Data input at the time of setting is carried out from the host device 30. The host device 30 is capable of carrying out inputs of various setting values such as an input of a setting value of a character size in addition to print densities.

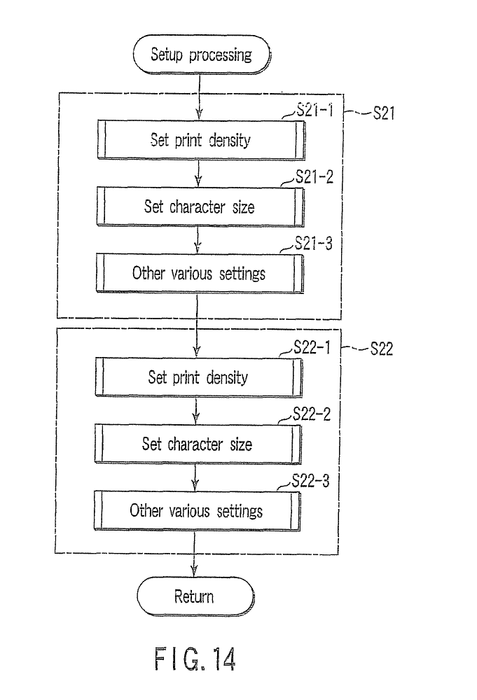

The host device 30 carries out various settings including settings of print densities with respect to the thermal printer body 10 by carrying out setup processing as shown in FIG. 14 on the basis of inputs of set data.

Setup processing will be described with reference to a flowchart shown in FIG. 14.

First, settings for the first thermal head 2 are carried out (step S21), and next, settings for the second thermal head 4 are carried out (step S22).

The settings for the first thermal head 2 at step S21 will be described.

In this setting process, processing for setting a print density is carried out (step S21-1), and processing for setting a character size is carried out (step S21-2), and other various setting processes are carried out (step S21-3). When the various settings for the first thermal head 2 are completed, next, the various settings for the second thermal head 4 at step S22 are carried out. In this setting process, processing for setting a print density is carried out (step S22-1), and processing for setting a character size is carried out (step S22-2), and other various setting processes are carried out (step S22-3). In this print density setting, setting is carried out at a rate of increase or decrease with respect to a reference electrical connection time, for example, 110% or the like of a reference electrical connection time. The setting information from the host device 30 is to be written into the memory device 52 of the RAM 51 in the thermal printer body 10.

The print data from the host device 30 are received at the communication I/F 14 on the basis of such settings in the thermal printer body 10. The received print data are divided into print data to be printed by the first thermal head 2 and print data to be printed by the second thermal head 4, and those are respectively converted into bitmap data. The first and second thermal heads 2 and 4 are respectively driven by the bitmap data to carry out printing on the front face 1a of the thermal recording paper 1 by the first thermal head 2, and to carry out printing on the back face 1b of the thermal recording paper 1 by the second thermal head 4. Then, when a series of printings are completed, the thermal recording paper 1 is cut by the cutter 6 to be discharged to the outside.

At this time, a distance printed by the first thermal head 2 is summed up to a cumulative used distance of the area 52a in the RAM 51, and one is counted up to the number of cuttings of the area 52a. In the same way, a distance printed by the second thermal head 4 is summed up to a cumulative used distance of the area 52b in the RAM 52 as a used distance, and one is counted up to the number of cuttings of the area 52b. Some data in the areas 52a and 52b are updated by carrying out printing operations in this way.

Then, when an attempt is made to confirm management information such as various setting data of the respective thermal heads 2 and 4, various states, various numbers of times, and the like which are set in the thermal printer body 10, an instruction to output the management information is issued from the host device 30 to the thermal printer body 10.

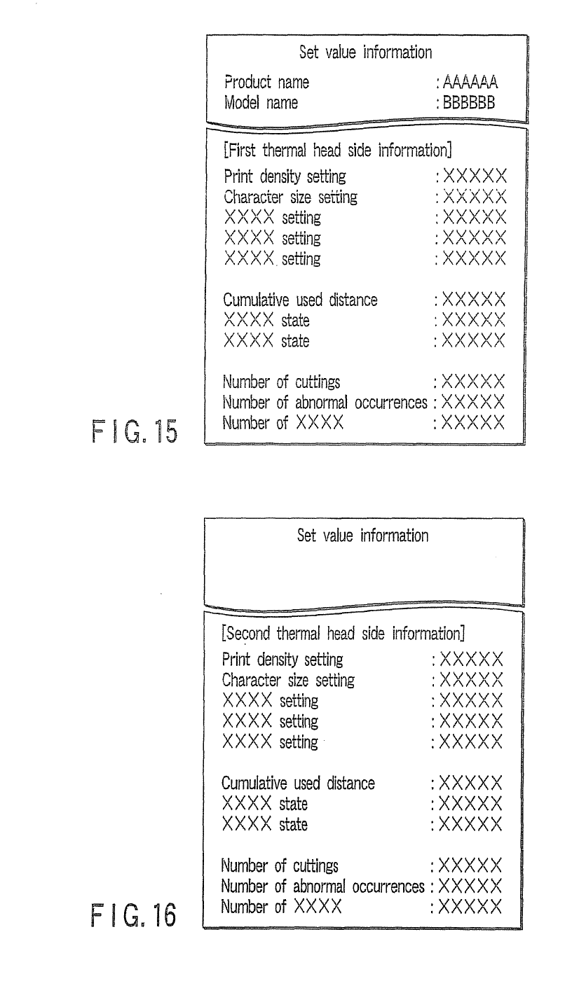

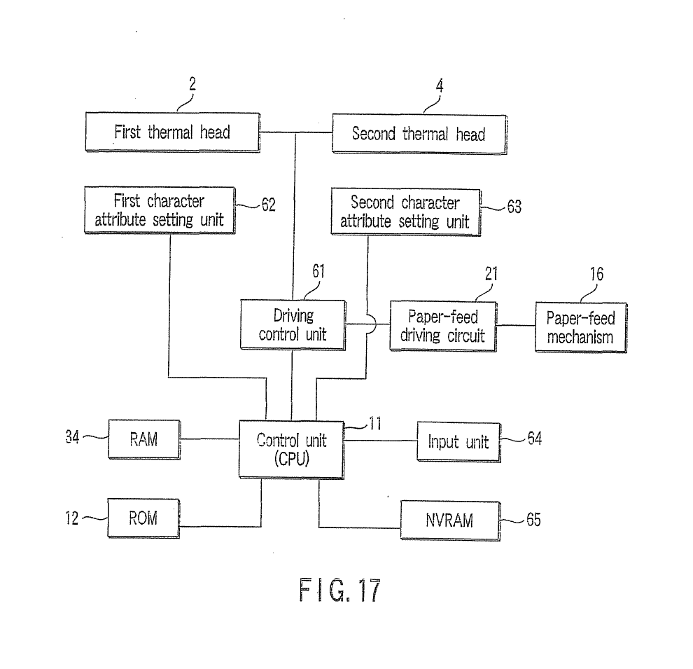

The CPU 11 sequentially reads out the management information stored in the area 52a in accordance with an instruction to output from the host device 30, and the management information is printed out in a form as shown in FIG. 15 onto the front face 1a of the thermal recording paper 1. In the same way, the management information stored in the area 52b is printed out in a form as shown in FIG. 16 onto the back face 1b of the thermal recording paper 1 (information printing means).

In such a structure, provided that the print data are printed so as to be divided onto the both sides of the front and back surfaces of the double-side thermal recording paper 1 by using the first thermal head 2 and the second thermal head 4, it is possible to make an attempt to save a quantity consumed of the thermal recording paper 1.

Further, it is possible for the first thermal head 2 and the second thermal head 4 to carry out printing-out onto the thermal recording paper 1 so as to set a desired print density or character size of a user at each surface.

In addition thereto, there are cases in which the contents of the management information on the first thermal head 2 and the management information on the second thermal head 4 are different from one another. Therefore, since it is necessary to confirm the current management information when the settings for management information are changed, the current management information is once printed out. With respect to the printing-out, the management information on the first thermal head 2 is printed out on the front face 1a of the thermal recording paper 1, and the management information on the second thermal head 4 is printed out on the back face 1b thereof. Note that, if it is possible to distinguish between the information on the front and back faces, all the management information may be printed out on the front face 1a or the back face 1b of the thermal recording paper 1. A desired item may be changed while visually recognizing the management information printed out. Accordingly, when a difference is generated in the print densities due to a difference in the temperature states between the respective thermal heads 2 and 4, or the like, visual recognition of the printed contents makes it possible to easily judge the state of adjustment of the print densities.

Note that settings for a variety of setting information with respect to the thermal printer body 10 have been carried out from the remote host device 30. However, input means (a keyboard, a display, and the like) may be provided in the thermal printer body 10, and a variety of setting information may be directly inputted thereby. Further, the double-side thermal recording paper has been used as a thermo-sensitive printing medium. However, the medium is not necessarily limited thereto, and it may be a thermo-sensitive printing medium formed from a sheet-like synthetic resin material.

Next, a double-side printer system according to a fourth embodiment will be described.

A schematic structure of a character attribute managing system mounted in the double-side printer system is shown as the fourth embodiment in FIG. 17. The present embodiment is to provide a character attribute managing system which is mounted in the double-side printer system carrying out double-side printing on a recording medium, and which carries out processing for character attributes separately onto the front and back faces of the recording medium, thereby making it easy to speed up double-side printing and to manage character attributes. Note that, among the constitutional parts in the present embodiment, constitutional parts which are the same as those in the first to third embodiments described above are denoted by the same reference numerals, and detailed descriptions thereof will be omitted.

A thermal printer body 10 has a first thermal head 2 carrying out printing-out onto a front face 1a of a double-side thermal recording paper 1, a second thermal head 4 carrying out printing-out onto a back face 1a thereof, a paper-feed driving circuit 21 driving a paper-feed mechanism 16 which feeds and carries the double-side thermal recording paper 1, a driving control unit 61 controlling the respective thermal heads 2 and 4 (which is the same as the head driving circuits 23 and 24), a CPU 11, a RAM 34, a ROM 12, a nonvolatile RAM (NVRAM) 65 which stores parameters and the like inputted by a user, first and second character attribute setting units 62 and 63 described later which are provided independently at the first and second respective thermal heads 2 and 4, and an input unit 64 which has a display function by which it is possible to confirm the set contents, and which is formed from a touch operation panel, a key input panel, or the like.

Note that, in the present embodiment, the double-side thermal recording paper 1 will be described by using a cut paper as an example. Accordingly, although not shown in the diagram, a sensor and the like for detecting a size of a recording paper is mounted. This is a structure in which the cutter and the cutter driving circuit in the first to third embodiments are not provided. It goes without saying that it is easy to mount those therein.

In the present embodiment, character attributes are information required for printing in a desired print style on a recording medium, and for example, fonts (Ming type, Gothic type, and the like), character styles (bold type, italic type, and the like), sizes, colors, strike-through, superscripts/subscripts, character rotation, black-and-white inversion, and the like may be considered as character attributes. Moreover, print directions (flip vertical, landscape, and the like) in units of pages, linefeed widths, character pitches, and the like are to be handled in the same way.

The character attribute managing system of the present embodiment is structured from the first character attribute setting unit 62 carrying out settings of character attributes for the first thermal head 2, the second character attribute setting unit 63 carrying out settings of character attributes for the second thermal head 4, the CPU 11 which respectively carries out settings/registrations into the first and second character attribute setting units 62 and 63 in accordance with print data and an user instruction, and transmits print data onto which character editing has been carried out in accordance with the settings/registrations to the respective thermal heads 2 and 4, the ROM storing a program for settings, and the NVRAM 65 storing information on character attributes. It goes without saying that the character attributes to be stored in the NVRAM 65 can be rewritten by an operation of a user, and it is possible to add or erase new character attributes appropriately. Such a character attribute managing system can be realized by functions of a personal computer.

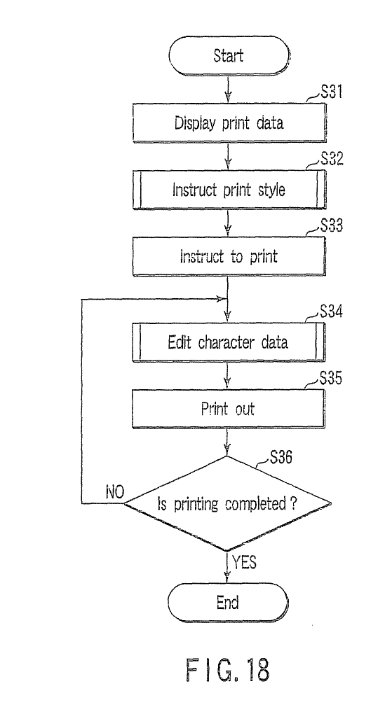

Next, printing out onto the double-side thermal recording paper 1 will be described with reference to a flowchart shown in FIG. 18.

First, a user displays print data to be printed out on a screen of a display of the host device 30 (step S31). The user instructs a print style, for example, settings of character attributes such as fonts and the like, a paper size of the double-side thermal recording paper 1 (or a size of a print area), and the like while seeing the print data (step S32). Note that the display of print data is not an essential requirement, and it suffices as long as it is possible to instruct a print style. Further, an instruction of a print style may be carried out from the input unit 15 provided at the thermal printer body 10 without using the host device 30.

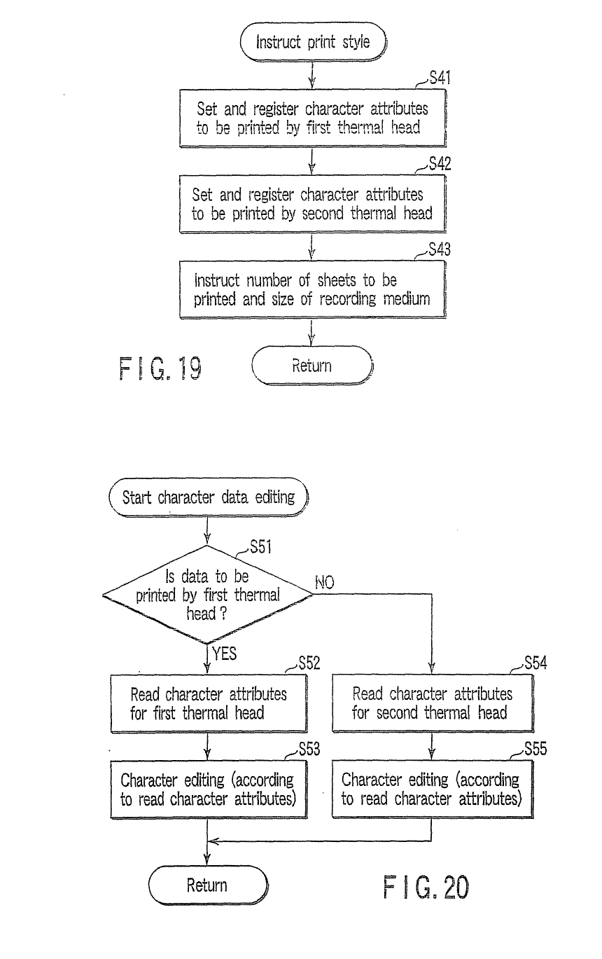

Here, a subroutine of instructing a print style will be described with reference to a flowchart shown in FIG. 19. First, for example, a font, a character size, and the like are specified from among many character attribute data stored in advance, and are set in and registered with the first character attribute setting unit 62 of the first thermal head 2 such that print data (mainly character data) to be printed on the front face of the double-side thermal recording paper 1 are made to be in a desired print style (step S41). Next, settings and registrations with respect to the second character attribute setting unit 63 of the second thermal head 4 are carried out in the same way (step S42). Next, items according to the recording paper such as a size of the double-side thermal recording paper 1, the number of printing sheets, and the like used for printing are specified (step S43), and the processing is returned to the routine of FIG. 18.

After the print style is specified, the user instructs to start printing (step S33). In accordance with the instruction to start printing, the CPU 11 reads out the print data in units of pages or by a data amount determined in advance from the RAM 34, and divides the data respectively into the character attribute setting units 62 and 63 to carry out character data editing thereof (step S34). Here, a subroutine of character data editing will be described with reference to a flowchart shown in FIG. 20.

First, the CPU 11 reads out the print data in units of pages or by a data amount determined in advance from the RAM 34, and judges whether or not the thermal head is a thermal head to handle the printing (step S51). To describe concretely, it is judged whether or not the print data is print data to be printed on the front face 1a of the double-side thermal recording paper 1 by the first thermal head 2. When the print data is print data to be printed by the first thermal head 2 in this judgment (YES), the character attributes set in the first character attribute setting unit 62 are read out (step S52), character editing of the print data is carried out in accordance with the character attributes (step S53), and the processing returns to the flowchart shown in FIG. 18. On the other hand, when the print data is not print data to be printed by the first thermal head 2 in the judgment at step S51 (NO), it is judged that the print data is print data to be printed on the back face 1b of the double-side thermal recording paper 1 by the second thermal head 4. Then, the character attributes set in the second character attribute setting unit 63 are read out (step S54), character editing of the print data is carried out in accordance with the character attributes (step S55), and the processing returns to the flowchart shown in FIG. 18.

Next, the CPU 11 instructs the driving control unit (head driving circuits) 61 to drive the specified first thermal head 2 or second thermal head 4 to print out the print data onto which character editing has been completed (step S35). Next, it is judged whether or not the printing according to the print data has been completed (step S36), and when all the print data have been outputted (YES), a series of printings are completed. On the other hand, when the printing has not been completed (NO) and print data to be printed have been still left, the processing returns to step S34, and character editing onto the print data is carried out. In the present embodiment, the CPU 11 is capable of carrying out character editing according to the character attributes in the second character attribute setting unit 63 in parallel (or at the same time) while carrying out character editing according to the character attributes in the first character attribute setting unit 62.

Further, in the present embodiment, the CPU 11 has read out the specified character attributes, and has carried out the character editing. However, the present invention may be structured so as to provide character edit functions to the respective character attribute setting units. Namely, the CPU 11 may be structured so as to transmit print data to the character attribute setting units 62 and 63, and to transmit the print data onto which character editing has been carried out in the character attribute setting units 62 and 63 to the thermal heads (the head drivers in the driving control unit), thereby reducing the processing load on the CPU 11.

As described above, in accordance with the present embodiment, since it is possible to individually set character attributes independently for the front face 1a and the back face 1b of the double-side thermal recording paper 1, it is easy for a user to instruct a print style. Further, it is possible to carry out processings of character attributes of print data in parallel by the character attribute setting units which set character attributes independently for each face of the double-side thermal recording paper 1, and speeding-up of print processing can be expected.

Next, a fifth embodiment will be described.

In the fourth embodiment described above, the routine is carried out such that printing-out is carried out while carrying out character editing in units of pages. However, in the fifth embodiment, print data onto which character editing is completed are sequentially stored in units of pages, and after character editing is carried out onto all the print data, the printing is started. Structural parts in the present embodiment are the same as those in the fourth embodiment described above, and those are denoted by the same reference numerals, and descriptions thereof will be omitted. However, although print data onto which character editing has been completed are to be stored in the RAM 34, a memory (buffer) may be separately provided.

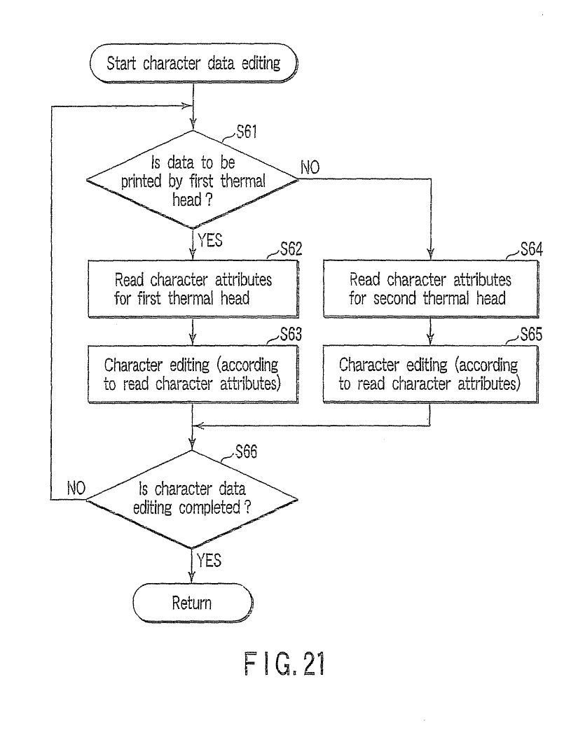

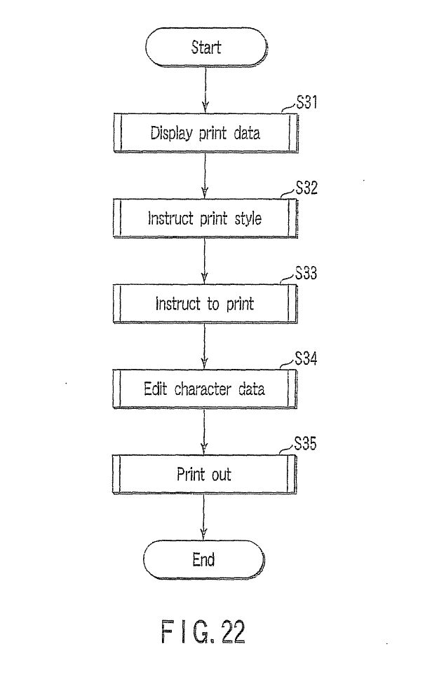

Next, printing-out onto the double-side thermal recording paper 1 in the fifth embodiment will be described with reference to flowcharts shown in FIGS. 21 and 22. Note that steps shown in the flowcharts shown in FIGS. 21 and 22 which are the same as the steps shown in the flowcharts shown in FIGS. 19 and 20 are denoted by the same step numbers, and the descriptions will be simplified.

First, a user displays print data to be printed out on the screen of the display of the host device 30, and instructs a print style and the like while seeing the print data (steps S31 and S32). Next, when printing start is instructed after the print style is specified (step S33), the CPU 11 respectively divides the print data read out of the RAM 34 into the character attribute setting units 62 and 63 to handle the print data in units of pages, and carries out character data editing thereof (step S34). Here, a subroutine of character data editing will be described with reference to the flowchart shown in FIG. 21.

First, the CPU 11 reads out the print data from the RAM 34, and judges whether or not the thermal head is a thermal head to handle the printing (step S61). When the print data is print data to be printed by the first thermal head 2 in this judgment (YES), the character attributes set in the first character attribute setting unit 62 are read out (step S62), and character editing of the print data is carried out in accordance with the character attributes (step S63), and the print data onto which the editing has been completed are stored in the RAM 34. On the other hand, when the print data is not print data to be printed by the first thermal head 2 in the judgment at step S61 (NO), it is judged that the print data is print data to be printed on the back face 1b of the double-side thermal recording paper 1 by the second thermal head 4. Then, the character attributes set in the second character attribute setting unit 63 are read out (step S64), character editing of the print data is carried out in accordance with the character attributes (step S65), and the print data onto which the editing has been completed are stored in the RAM 34. After the editings are respectively completed at the respective steps S63 and S65, it is judged whether or not character editing has been completed onto all the print data (step S66).

When the character editing has not been completed onto all the print data in this judgment (NO), the processing returns to step S61, and character editing is carried out onto the following print data (in units of pages). On the other hand, when character editing has been completed onto all the print data (YES), the processing returns to the flowchart shown in FIG. 22.

Next, the CPU 11 reads out the print data onto which character editing has been completed from the RAM 34, and instructs the driving control unit 61 to drive the specified first thermal head 2 or second thermal head 4 to print out the print data (step S35). Thereafter, a series of printings are completed.

Further, in the present embodiment, the printing is started after the character editing has been completed. However, this is not limited thereto, and after character editing of print data is completed to some extent, the printing may be started when print data onto which character editing has been carried out reaches a certain storage capacity along the way.

As described above, the present embodiment can obtain the sane effect as that of the first embodiment described above.

Further, in the fourth and fifth embodiments described above, the example of the double-side thermal recording paper which has been cut in a predetermined size (A4, B4, or the like) has been described as a thermo-sensitive medium. However, the medium is not limited thereto, and a thermo-sensitive medium may be in a form which is long and rolled up in a roll form.

Note that, with respect to the character attribute managing system of the present invention, the example of the printer in which the thermal heads are mounted as record heads of a double-side printer has been described. However, the system is not limited thereto, and additionally, the character attribute managing system can be easily applied to an inkjet printer device or a dye sublimation printer device. Further, the character attribute managing system can be applied not only to a single printer, but also as a double-side printing unit which is mounted in a cash register calculator, a cash dispenser, a ticket issuing machine, a ticketing machine for railway tickets and the like, a copier, or a telephone equipped with a fax.

Note that, in the first to fifth embodiments described above, although not shown in the drawings, a feed section which feeds the unprinted double-side thermal recording paper 1, and a storage section which stores the printed double-side thermal recording paper 1 as well are provided. These feed section and storage section have general structures, and may be structured so as to be able to cope with the case in which the double-side thermal recording paper 1 is a cut paper or a roll paper.

What is claimed is:

1. A method for controlling a double-side printer system which prints print data on a thermal recording paper in which thermo-sensitive layers are formed on front and back faces serving as a first recording surface and a second recording surface, the method comprising:
respectively sensing temperatures of heater elements provided in a first thermal head which prints print data on the first recording surface, and temperatures of heater elements provided in a second thermal head which prints print data on the second recording surface; and
controlling to turn on/off electrical connections to the respective heater elements such that respective sensed temperatures are made to be the same temperature between the thermal heads.

2. The method for controlling a double-side printer system according to claim 1, wherein
the electrical connections to the respective heater elements are controlled to be turned on/off such that respective temperatures sensed from the heater elements provided in the first thermal head and the heater elements provided in the second thermal head are made to be set temperatures which are respectively set.

3. The method for controlling a double-side printer system according to claim 1, wherein
head information including print densities which are respectively set for the first thermal head and the second thermal head are stored so as to be distinguished for each thermal head, and
when the head information is printed out, the head information according to the first thermal head is printed on the first recording surface of the thermal recording paper, and the head information according to the second thermal head is printed on the second recording surface of the thermal recording paper.
